(19) United States
(12) Patent Application Publication
(10) Pub. No.: US 2012/0330698 A2
(43) Pub. Date: Dec. 27, 2012

(54) System for Destination-Based Travel Planning and Booking

(75) Inventor: Terry Gilliam, North Kingston, RI (US)

(73) Assignee: WUHU LLC, Merrimack, NH (US)

(21) Appl. No.: 12/661,306

(22) Filed: Mar. 15, 2010

Related U.S. Application Data
(60) Provisional application No. 61/210,098, filed on Mar. 13, 2009.

(51) Int. Cl. G06Q 10/00

(52) U.S. Cl. 705/6

(57) ABSTRACT

A method of travel planning and booking that allows a traveler to create on a website a profile of travel preferences, stores the profile of travel preferences, and allows the traveler to enter on the website a travel plan comprising a departure address, proposed destinations and arrival and departure times for each destination. It then identifies options for the travel plan based on the profile of travel preferences.

### CROSS-REFERENCE TO RELATED APPLICATIONS

The present application claims the benefit of Provisional Patent Application Ser. No. 61/210,098 filed Mar. 13, 2009, which is incorporated herein by reference.

### TECHNICAL FIELD OF THE INVENTION

The present invention relates to a method and apparatus for travel planning and booking. More specifically, it relates to a method and apparatus for destination-based travel planning and booking.

### BACKGROUND OF THE INVENTION

Today, travel planning puts the burden on the prospective traveler (the “traveler”) to research air, ocean, and ground transportation; accommodations; dining; entertainment and sightseeing; and other points of interest; based upon planned dates of departure and arrival for each destination in an itinerary. A traveler must painstakingly research the options in each of these fields separately in an attempt to coordinate them into the best possible travel plan. The entire travel planning process may also be governed by budgetary and other parameters, such as special needs associated with diet restrictions and disabilities. Undertaken in the way required by websites such as expedia.com, travel planning for a complex itinerary involving several destinations and a variety of needs and preferences for a large family or group can quickly overwhelm a traveler.

For example, accommodations for a family for each destination in a three-city itinerary require researching accommodation locations and their proximity to the points of interest to the family in each city. Once these are ascertained, availability, affordability, dining options, children's programs, pet care and other criteria of the family must be researched and actual bookings made. The likelihood is that a family, or any group or its agent, will have to explore many options through many research iterations before finding just the right accommodations. Moreover, this iterative, time and energy-consuming process will need to be repeated for each destination in the itinerary.

Processes similar to that described to plan and book accommodations must be undertaken for inter-city travel (air, ocean and ground); for dining (restaurant ratings and type of cuisine); for intra-city travel to business appointments, meeting venues vacation sights, entertainment venues, restaurants and other destinations (rental cars—which vendor and what type of vehicle; limousines, black car or full limousine; buses; taxis; and trains and class of service); for entertainment and sightseeing (availability, classes of services, cost, time options and reviews); for shopping (hours and locations of specific shops and most frequented shopping venues); and for festivals or other special events (times, costs, traditions, etiquette and the like).

### SUMMARY OF THE INVENTION

One aspect of the present invention is a method of travel planning and booking comprising, allowing a traveler to create on a website a profile of travel preferences in at least one of the areas of transportation, accommodations, dining, entertainment and sightseeing, storing the profile of travel preferences in memory controlled by a digital computer, allowing the traveler to enter on the website a travel plan comprising a departure address, proposed destinations and arrival and departure times for each destination, using the digital computer and one or more internet search engines to identify options for the travel plan based on the profile of travel preferences in at least one of the areas of transportation, accommodations, dining, entertainment and sightseeing, presenting the identified options to the traveler, allowing the traveler to select the identified options in whole or to select the identified options in part and to select different options in part, and creating an itinerary based on the traveler's selections and offering to book the itinerary.

These aspects of the invention are not meant to be exclusive and other features, aspects, and advantages of the present invention will be readily apparent to those of ordinary skill in the art when read in conjunction with the following description, appended claims, and accompanying drawings.

### BRIEF DESCRIPTION OF THE DRAWINGS

The foregoing and other objects, features, and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a screenshot of one embodiment of the present invention.

FIG. 2 is a screenshot of one embodiment of the present invention.

FIG. 3 is a screenshot of one embodiment of the present invention.

FIG. 4 is a screenshot of one embodiment of the present invention.

FIG. 5 is a screenshot showing some features present in one embodiment of the present invention.

FIG. 6 shows one embodiment of a user profile of one embodiment of the present invention.

FIG. 7 shows one embodiment of a user profile of one embodiment of the present invention.

FIG. 8 shows one embodiment of a user profile of one embodiment of the present invention.

FIG. 9 shows one embodiment of a user profile of one embodiment of the present invention.

FIG. 10 shows one embodiment of a user profile of one embodiment of the present invention.

FIG. 11 shows a flowchart of one embodiment of the present invention.

FIG. 12 shows a flowchart of one embodiment of the present invention.

FIG. 13 shows a flowchart of one embodiment of the present invention.

FIG. 14 shows a flowchart of one embodiment of the present invention.

FIG. 15 shows a flowchart of one embodiment of the present invention.

FIG. 16 shows a flowchart of one embodiment of the present invention.

FIG. 17 shows a flowchart of one embodiment of the present invention.

FIG. 18 is a flowchart of the high-level architecture of one embodiment of the present invention.

### DETAILED DESCRIPTION OF PREFERRED EMBODIMENTS

The present invention is a system, for destination-based travel planning and booking. A preferred embodiment of the present invention comprises a website at which a traveler—a registrant—registers and creates a profile of his travel preferences. Such a registration can include, among other information, business and residence addresses and associated contact information, preferences for classes and types of travel means (including specific carriers and seating), accommodations (including specific hotel names), dining (including minimum acceptable restaurant ratings, cuisines and table location preferences), and ground transport (including specific rental car providers or car services). Frequent traveler numbers can also be inputted. The registrant's information is then stored in any one of a number of types of memory known to those skilled in the art controlled by a central processing unit of a digital computer. The registrant is then issued a unique user identification and password.

A preferred embodiment of the system also allows a registrant to log onto the website and create a travel plan by inputting, for example, into a formatted html page, his departure address (home or business selected from profile), the destinations he plans to visit, the dates of such visits, and the desired arrival and departure times for each such destination. The website then provides radio dials or other means known to those skilled in the art, such as pull-down menus, to indicate for each destination the registrant's needs in a number of fields including, among others, desired travel means, accommodations, dining, ground transportation and sites the registrant night like to see or events he might like to attend at each destination and on what days and hours he would like to do so.

The preferred embodiment then factors in all of the registrant's travel preferences, as expressed in his profile, and presents available options to the registrant on a website or a mobile phone or other communication means, in every selected field. It does this through the central processing unit using search engines and other Internet tools and researching local websites at each destination to narrow down or illuminate the options in every one of registrant's chosen fields to fit within his preferred criteria. The registrant then accepts a preferred option, makes a different choice from the options presented, or overrides the system and enters his own option. Once registrant's selections are made, the system creates the itinerary and offers to book it, either in parts selected by the registrant, or in its entirety. Again, if the registrant accepts the offer, the system books the itinerary. It should be noted that the system can also provide the same services for a travel agent on behalf of a traveler.

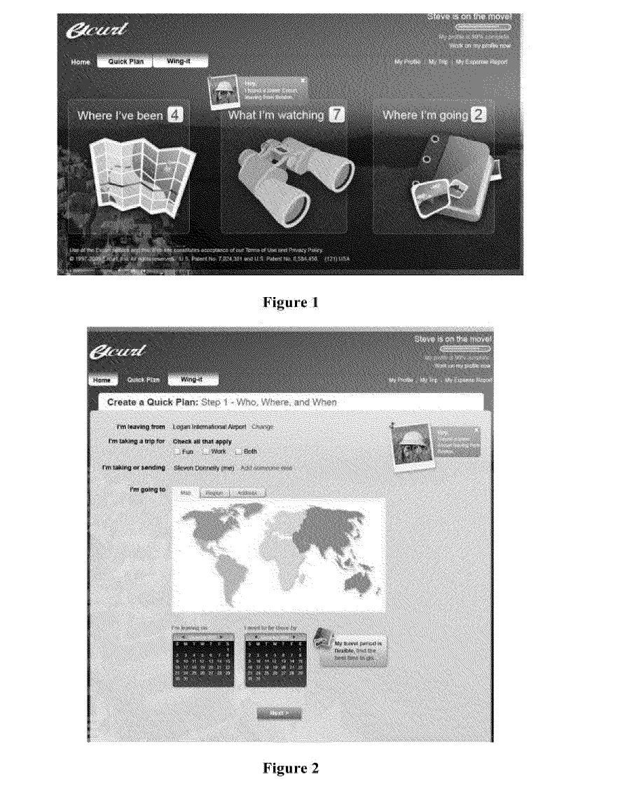

FIG. 1 shows a screenshot of one embodiment of the present invention. One embodiment of the present invention allows a traveler and the system of the present invention to track where they have been, where they are going, and to “watch” various potential additional to a travel itinerary.

FIG. 2 shows a screenshot of one embodiment of the present invention. One embodiment of the present invention provides a mechanism for a traveler to enter in information about a planned trip to create a profile of travel preferences.

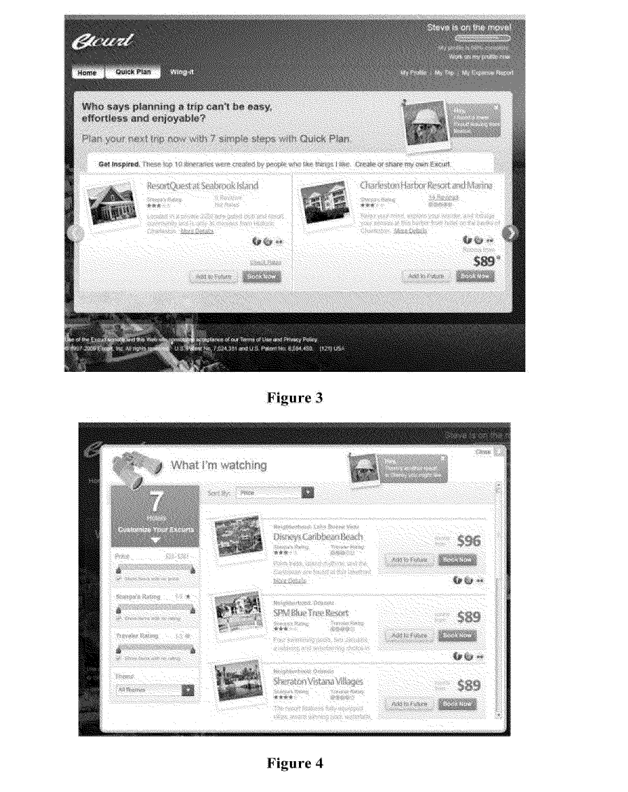

FIG. 3 shows a screenshot of one embodiment of the present invention. One embodiment of the present invention provides an easy, effortless, and enjoyable way to plan a trip. One embodiment provides a traveler with inspiration by providing a list of itineraries most likely to suit a particular traveler.

FIG. 4 shows a screenshot of one embodiment of the present invention. One embodiment of the present invention allows travelers to track items, including resorts, and the like. In one embodiment, the traveler can customize the results by selecting price ranges, ratings, and the like.

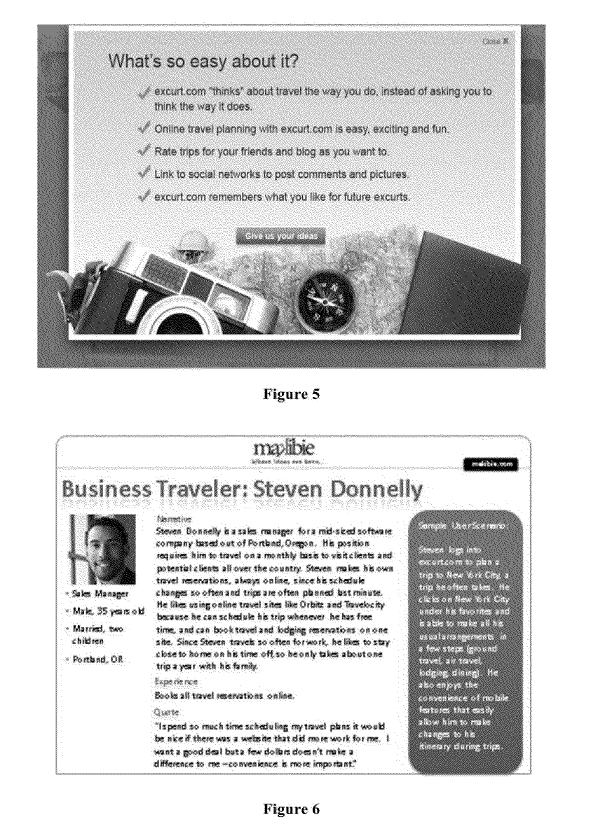

FIG. 5 shows a screenshot showing some features present in one embodiment of the present invention. One embodiment of the present invention provides a traveler with ratings systems, blogs, links to social networks, the ability to post pictures and comments, and remembers the traveler so that future trip planning is even easier and more accurate.

Once travel is underway, should there be any changes in plans, the system allows a registrant to access his itinerary to make the desired changes. It then rearranges the itinerary accordingly. This might involve cancellations, changes of time or other booking modifications. Itineraries are issued to registrants in both soft and optional hard copies, and the system retains copies of active itineraries on its servers.

The overall process described herein whereby the system plans and books travel maps to the way people think about business and personal travel and searches out the appropriate options for them, rather than requiring them to search out the air, ocean, ground, accommodations, dining particulars, etc. themselves, as is the case with all existing online travel sites.

Another preferred embodiment of the system can also learn with each use by a registrant. In this embodiment, a registrant logs onto the website and creates a travel plan and indicates his needs in a number of fields. For registrants who have not previously created a profile of travel preferences, the system presents available options to the registrant based on the most popular options (or some other criteria independent of the registrant's actual preferences) in each field. The registrant then accepts a preferred option, makes a different choice from the options presented, or overrides the system and enters his own options. For future travel plans for the registrant, the system can use algorithms based on past choices in a field to predict future choices in that field. For example, in a Boston, Singapore, Hong Kong, Boston itinerary, it can propose specific air carriers and hotels for each destination based upon a registrant's prior selections. Any of these proposed choices can easily be overridden by the registrant.

In addition, in other preferred embodiments, the system can discover a better class of available services, for example, “business class” air or hotel, and advise the registrant of this and of the price difference to upgrade. Registrants can choose in their profiles whether or not they wish to be advised of the possibility of such upgrades.

To lead the marketplace, one embodiment of the present invention comprises the following features: user accounts, forum/community features, and a mix of professionally-generated and user-generated tips and recommendations. User accounts coupled with a robust user profile allows users to customize solutions to fit their particular needs. The forum/community features provides an active, vibrant, engaged user community, and enhances site stick ness a brand recognition, while hastening adoption by others. A mix of professionally-generated and user-generated tips and recommendations allows travelers to utilize advice from professionals and their peers. Most of all, the present invention gives travelers what they want: recommendations that are relevant to their preferences, values, and usage patterns.

In addition to the previously discussed features, one embodiment of the present invention seeks to simplify the process and make travel planning fun and easy. The travel-related sites surveyed to date were all user-directed; it was up to the user to explore the offerings at each site, at his or her own pace. A user who just wants to log in and make travel arrangements he or she knows are sound is at a serious disadvantage when using these sites. A solution that leverages Rich Internet Application (RIA) coupled with robust back-end database technology as with the present invention enables users to explore, plan, and book travel within a few clicks.

Another feature of the present invention is the ability to integrate seamlessly with third-party social networking sites. A web solution that integrates with third-party social networking sites like Facebook to allow users to plan trips collectively will provide travelers' with more options than are currently available.

Yet another feature of the present invention is a mobile app. Here, a web solution that offers a tight, well-integrated mobile application that allows users to explore and make late-breaking changes to their travel plans using GPS technology to give location-related tips and recommendations makes travel planning more flexible and robust. The present invention meets the needs of the modern traveler. Some of the core functionalities available in one embodiment of the present invention are listed below in Table 1. Some of the various tools present in one embodiment of the present invention are listed below in Table 2.

TABLE 1
Core functionality

| Core Functionality | Description |
|---|---|
| Home Dashboard | Landing page where a user can quickly and easily get to anywhere |
| | on the site and get a snapshot of upcoming trips. |
| Quick Plan | Wizard that walks a user through planning a trip with specific |
| | requirements. offering educated recommendations throughout the |
| | process. |
| excurt | Wizard that walks user through planning a trip without |
| | requirements, offering educated recommendations that are |
| | available and applicable throughout the process. |
| Sherpa | Helps with things like missed flights, change in plans or need help, |
| | and makes recommendations based on users' preferences and past |
| | experiences |

TABLE 2
Tools

| Tools | Description |
|---|---|
| Blog | Area users can share their experiences. |
| Trip Planner | Online trip planning tool that makes traveling easy and fun, |
| | guiding the user from door to door. |
| Itinerary | Overview of a trip and all the details. |
| Rating | Rate a trip based on experience. |
| Social Network | Link to social networks with ability to post pictures and status |
| | from trips. |
| Instant Booking/GPS | Quickly see what is around user location and book a reservation in |
| | the event plans change. |
| Profile | Personal information about user including travel preferences. |
| Progress Tracker | Shows user where they are in the hooking process. |
| Expense Report | Quickly and easily create an expense report based on trip activities |
| | and submit to employer/client. |
| Rewards | Ability to view and redeem all rewdrd points and frequent flier |
| | miles. |

One aspect of the present invention is the ability to have several particular types of user profiles, including business traveler, personal traveler, a combination of both, or even the ability to create a traveler profile for another as is the case for an executive assistant or travel agent.

Referring to FIG. 6, there is an example of a business traveler's profile. The profile contains information relating to his lifestyle and travel habits, as well as other personal information such as name, age, residential address, and the like. In FIG. 6, the business traveler logs in to plan a trip to New York City, which is a trip he often takes. He clicks on New York City under his favorites and is able to make all his usual arrangements in a few steps (ground travel, air travel, lodging, dining). He also enjoys the convenience of mobile features found in one embodiment of the present invention because that easily allows him to make changes to his itinerary during trips.

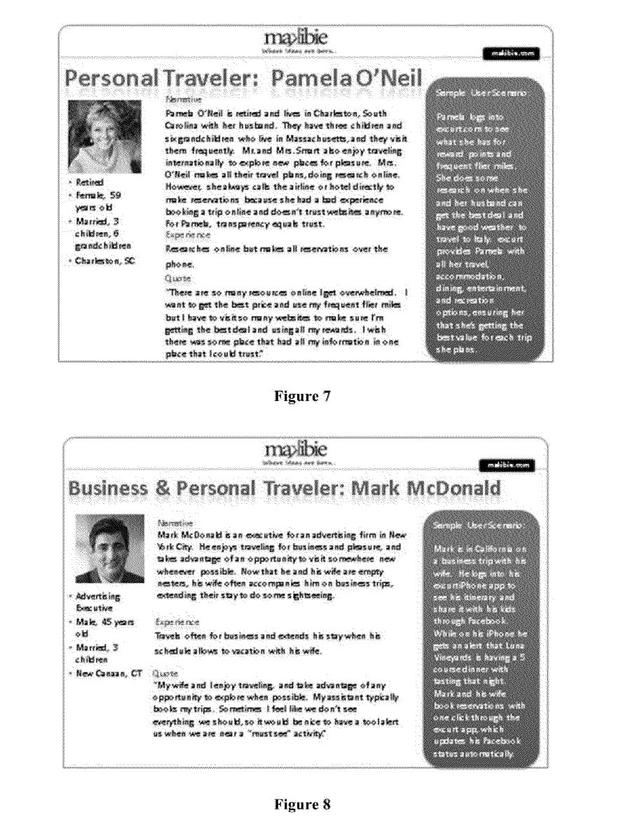

Referring to FIG. 7, there is an example of a personal traveler's profile. The profile contains information relating to her lifestyle and travel habits, as well as other personal information such as name, age, residential address, and the like. In FIG. 7, the personal traveler logs in to see what she has for reward points and frequent flier miles. She does some research on when she and her husband can get the best deal and have good weather to travel to Italy. One embodiment of the present invention provides her with all her travel, accommodation, dining, entertainment, and recreation options, ensuring her that she's getting the best value for each trip she plans.

Referring to FIG. 8, there is an example of a combination business and personal traveler's profile. The profile contains information relating to his lifestyle and travel habits, as well as other personal information such as name, age, residential address, and the like. In FIG. 8a the combination business and personal traveler is in California on a business trip with his wife. He logs into his Mobile app to see his itinerary and share it with his kids through Facebook. While on his mobile device he gets an alert that Luna Vineyards is having a five course dinner with tasting that night. Mark and his wife book reservations with one click through the mobile app, which then updates his Facebook status automatically.

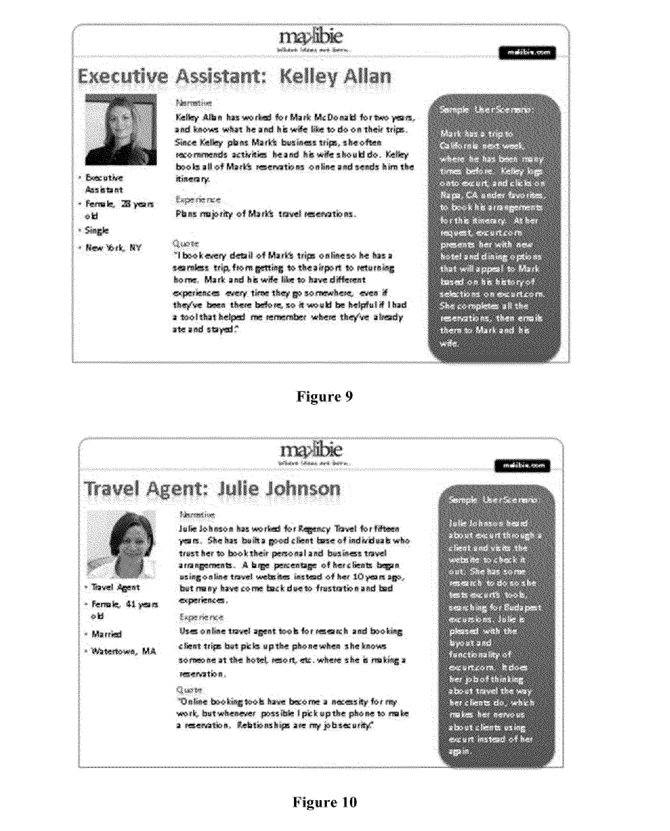

Referring to FIG. 9, there is an example of an executive assistant creating and/or accessing a profile for her boss. The profile contains information relating to his lifestyle and travel habits, as well as other personal information such as name, age, residential address, and the like. In FIG. 9, the executive assistant a trip to California next week for her boss. He has been there many times before. The assistant logs in and clicks on Napa, Calif. under favorites, to book his arrangements for this itinerary. In one embodiment of the present invention, and at her request, the assistant is presented with new hotel and dining options that will likely appeal to her boss based on his history of selections. She completes all the reservations, and then emails them to her boss and his wife.

Referring to FIG. 10, there is an example of a travel agent using the present invention to research travel for a potential customer. The profile contains information relating to her lifestyle and travel habits, as well as other personal information such as name, age, residential address, and the like. In FIG. 10, the travel agent was referred to the present invention by client and visits the website to check it out. She has some research to do so she tests some of the tools available in one embodiment of the present invention. The travel agent searches for Budapest excursions, and is pleased with the layout and functionality of the site, but since it does her job of thinking about travel the way her clients do, she is nervous about clients using the present invention instead of her again.

Online travel planning is a large business, and the present invention offers many improvements over present technology. Travel reservations booked online last year were $86 billion, but only 29% of leisure travelers say it's worth the savings to book online because of the hassle. Traveler reviews are a recent addition to the medium that users take into account. For example, 36% of travelers look at rankings when choosing hotels and 73% said those reviews affected their choice. Interestingly, 29% of those surveyed have written reviews.

Due to the complexity and lack of features available presently in online travel planning systems, an increasing number of travelers are choosing to book through travel agents to save time. For example, 90% of cruises are still booked through travel agents. There are 15% fewer travelers that enjoy using the web in 2009 than did in 2007. There is also a decrease in the impression that travelers have of the current online travel planning options, for example, 33% of US online travelers feel the web does a good job at presenting choices, which is down from 38% in 2008.

There are many common complaints about online booking including paper tickets, paper tickets that didn't arrive, incorrect data (user error), auto-filled data (wrong users), double booking, hotels that have no record of reservation, and the like. Travelers also find the need to visit numerous sites to effectively plan a trip online. In one survey, 91% of the travelers said they search multiple internet sites when researching travel. There, 75% of the travelers said they search more than 3 websites, and 20% of the travelers said they search more than 6 websites. The method and system of the present invention offers a solution to these issues.

In one embodiment of the present invention, the information will be organized around the way travelers think. In one embodiment, the information will be organized by simple interactions, including Where am I going? Why am I traveling? Who am I traveling with? When do I go? When do I return? and the like.

In another embodiment, the present invention will provide complete trip planning comprising transportation, accommodations, dining, entertainment, and the like. In one embodiment of the present invention, the system learns about its users. This can be done by creating, storing and tracking travelers' preferences, purchase behaviors, usage, connections, and the like.

There are many core building blocks that the present invention offers which make online travel planning fun, easy, exciting, and enjoyable. The present invention has an intuitive user interface that is easily understood; a learning “engine” that delivers highly personalized information and recommendations; well-designed components that snap together easily; robust searches with well defined, tagged, and informative content; and role-based architecture to display the most relevant content, tools, and resources by role.

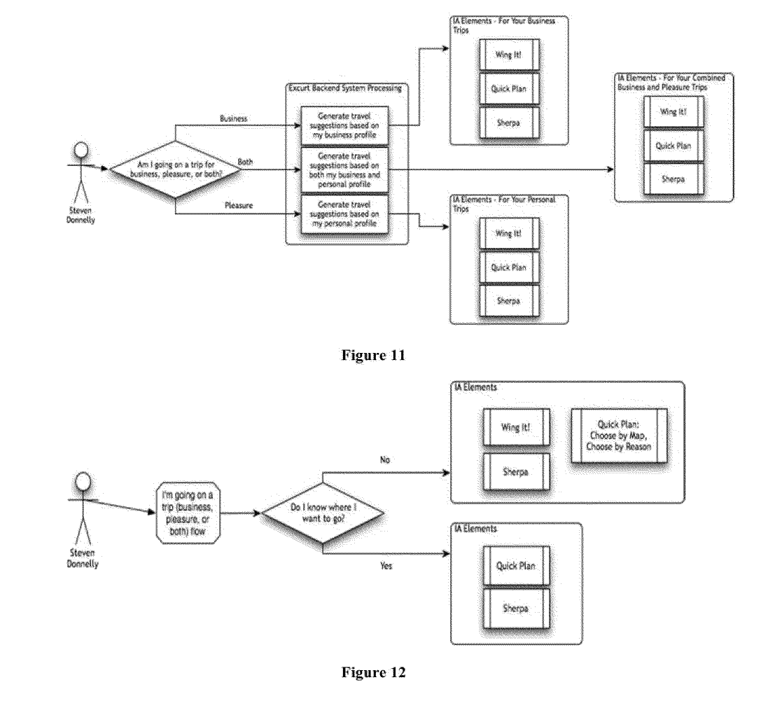

FIG. 11 shows a flowchart of one embodiment of the present invention. In one embodiment of the present invention, a traveler can select the purpose of their trip as personal, business, or both and there will be travel suggestions generated to suit the purpose of the traveler's trip. In one embodiment of the present invention, there is also the ability to have varying levels of freedom to direct the search results as compared to using the system to select choices based on previous trips and/or current selections and behavior. Some of the various levels are wing it, quick plan, sherpa, and the like. Wing it utilizes the system's ability to predict and sort results, quick plan allows for minimal input from the traveler, and sherpa assists the traveler throughout the process so that the traveler can fine tune at many stages of the travel planning process.

FIG. 12 shows a flowchart of one embodiment of the present invention. In one embodiment of the present invention a traveler's choices may be organized by whether or not they know there they want to go. If they do, then there are still ways to fine tune the results, or have the system and method of the present invention use the traveler's past and present behavior to predict which recommendations will be best-suited for a particular traveler on a particular trip. If a traveler does not know where they want to go there are even more options available such as wing it, sherpa, and quick plan. There, quick plan may include choosing where to go by map, reason for travel, and the like.

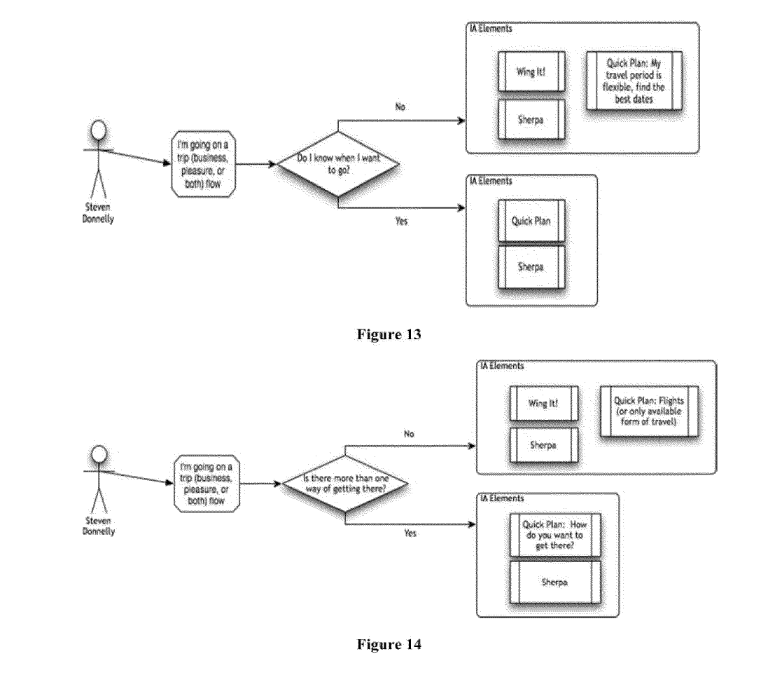

FIG. 13 shows a flowchart of one embodiment of the present invention. In one embodiment of the present invention a traveler's choices may be organized by whether or not they know when they want to go. If they do, then there are still ways to fine tune the results, or have the system and method of the present invention use the traveler's past and present behavior to predict which recommendations will be best-suited for a particular traveler on a particular trip. If a traveler does not know when they want to go there are even more options available such as wing its sherpa, and quick plan. There, quick plan may include choosing when to go by best dates, or by selecting that the length of the trip is flexible, and the like.

FIG. 14, shows a flowchart of one embodiment of the present invention. In one embodiment of the present invention a traveler's choices may be organized by whether or not there is more than one way to get to a particular destination. If there is, then there are still ways to fine tune the results, or have the system and method of the present invention use the traveler's past and present behavior to predict which recommendations will be best-suited for a particular traveler on a particular trip. If there is only one way to get to a particular destination there are still several options available such as wing it, sherpa, and quick plan. There, quick plan may include choosing flights, or carriers, and the like if flying is the only way to get to a particular destination.

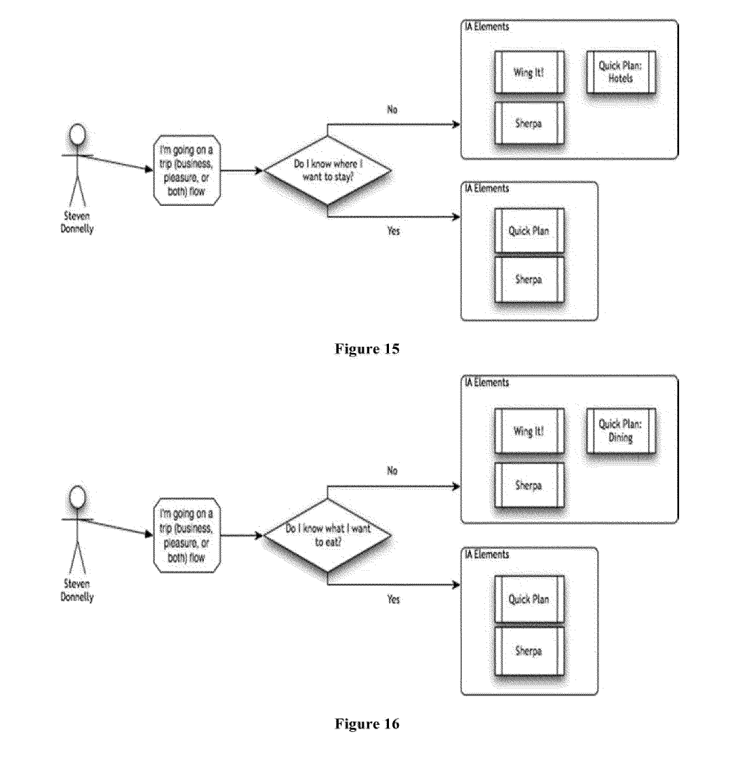

FIG. 15 shows a flowchart of one embodiment of the present invention. In one embodiment of the present invention a traveler's choices may be organized by whether or not they know where they want to stay. If they do, then there are still ways to fine tune the results, or have the system and method of the present invention use the traveler's past and present behavior to predict which recommendations will be best-suited for a particular traveler on a particular trip. If a traveler does not know where they want to stay there are even more options available such as wing it, sherpa, and quick plan. There, quick plan may include choosing where to stay by hotel and the like.

FIG. 16 shows a flowchart of one embodiment of the present invention. In one embodiment of the present invention a traveler's choices may be organized by whether or not they know where or what they want to eat. If they do, then there are still ways to fine tune the results, or have the system and method of the present invention use the traveler's past and present behavior to predict which recommendations will be best-suited for a particular traveler on a particular trip. If a traveler does not know where or what they want to eat there are even more options available such as wing it, sherpa, and quick plan. There, quick plan may include choosing the type of food, the restaurant, and the like.

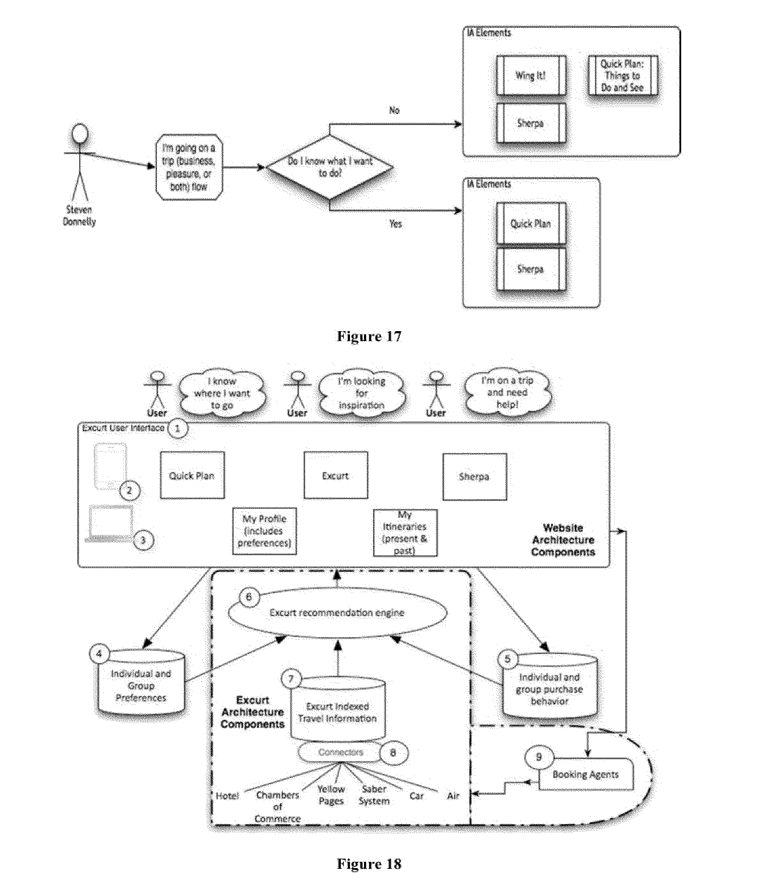

FIG. 17 shows a flowchart of one embodiment of the present invention. In one embodiment of the present invention a traveler's choices may be organized by whether or not they know what they want to do. If they do, then there are still ways to fine tune the results, or have the system and method of the present invention use the traveler's past and present behavior to predict which recommendations will be best-suited for a particular traveler on a particular trip. If a traveler does not know what they want to do there are even more options available such as wing it, sherpa, and quick plan. There, quick plan may include choosing from various things to do and see, and the like.

FIG. 18 shows a flowchart of one embodiment of the present invention. One embodiment of the present invention organizes the information in numerous ways comprising various elements of a trip including such things as where to go, what to do, whether they traveler is looking for inspiration, or whether or not they need help. This data is provided through user interaction 1. The present invention provides various levels of control to the traveler to direct the selection process 2, but it also provides robust mechanisms that learn from and adapt to particular traveler's behavior to provide recommendations that closely match a traveler's needs. Several levels of traveler involvement comprises wing it, Sherpa, quick plan and the like. The system and method of the present invention also utilizes present behavior of the traveler and any past itineraries of the traveler 3 to feed into the recommendation generation portion of the invention 6. There, individual and group preferences 4 are considered along with group and individual purchase behavior 5. The recommendation engine 6 then accesses indexed travel information 7 from various sources through connectors 8 to provide recommendations that best suit a particular traveler for a particular trip. Once the recommendations have been provided to a traveler, the traveler is able to book the recommendations in whole, in part, or even provide more information to complete the booking 9.

Some aspects of the components present in the website architecture of one embodiment of the present invention are shown in Table 3, below.

TABLE 3
Website architecture components

| | |
|---|---|
| Excurt User | Web 2.0 architecture that supports wizards for Quick Plan, push alerts |
| Interface | (AJAX) for Sherpa |
| iPhone App | Location based search (GPS), wizards, itinerary and contact info by trip. |
| Web Access | Multi-browser support for breadth of audience. High availability for |
| | 24 × 7 access. |
| Preferences | Stored preferences for excurt users, by individual and by profile group. |
| | Natural-language text-search data. |
| Behavior | Stored behavior of excurt users by system functionality. Natural- |
| | language text-search data. |
| Recommendation | Custom algorithm for weighing data from preferences and behavior. |
| engine | |
| Indexed travel | Natural-language text-search data from multiple industries and sources. |
| information | |
| MakibieConnect © | Connectors to negotiated APIs, public web services, available search |
| | data, and partners/affiliates. |
| Booking Agents | API to negotiate plans to itineraries. Payment gateway/processor. |

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention.

What is claimed is:

1. A method of travel planning and booking comprising,
allowing a traveler to create on a website a profile of travel preferences in at least one of the areas of transportation, accommodations, dining, entertainment and sightseeing,
storing the profile of travel preferences in memory controlled by a digital computer,
allowing the traveler to enter on the website a travel plan comprising a departure address, proposed destinations and arrival and departure times for each destination,
using the digital computer and one or more internet search engines to identify options for the travel plan based on the profile of travel preferences in at least one of the areas of transportation, accommodations, dining, entertainment and sightseeing,
presenting the identified options to the traveler,
allowing the traveler to select the identified options in whole or to select the identified options in part and to select different options in part, and
creating an itinerary based on the traveler's selections and offering to book the itinerary.
